(19) United States
(12) Patent Application Publication
(10) Pub. No.: US 2024/0219631 A1
(43) Pub. Date: Jul. 4, 2024

(54) SILICON-BASED RECONFIGURABLE MICROWAVE PHOTONIC MULTI-BEAM FORMING NETWORK CHIP

(71) Applicant: Shanghai Jiao Tong University, Shanghai (CN)

(72) Inventors: Liangjun LU, Shanghai (CN); Ziheng NI, Shanghai (CN); Linjie ZHOU, Shanghai (CN); Jianping CHEN, Shanghai (CN); Jiao LIU, Shanghai (CN)

(21) Appl. No.: 18/608,568

(22) Filed: Mar. 18, 2024

Related U.S. Application Data
(63) Continuation of application No. PCT/CN2021/123519, filed on Oct. 13, 2021.

(30) Foreign Application Priority Data
Sep. 24, 2021 (CN) 202111122981.3

(51) Int. Cl. G02B 6/12; G01S 7/481; G01S 17/02

(52) U.S. Cl. CPC G02B 6/12011; G01S 7/4818; G01S 17/02; G02B 6/12004

(57) ABSTRACT

A silicon-based reconfigurable microwave photonic multi-beam forming network chip comprises an optical fiber coupler, an optical switch array, an optical divider, an ultra-wideband continuously adjustable optical true delay line array and a detector array; the optical fiber coupler is configured for inputting a single-sideband modulated optical signal of a microwave photonic phased array radar; the optical switch array and optical divider are configured for forming the reconstruction of the number of array elements used for a microwave photonic multi-beam and a microwave photonic single-beam; the ultra-wideband continuously adjustable optical true delay line array is configured for independently adjusting the delay on each microwave array element; and the detector array is configured for outputting a microwave signal. The chip provides large instantaneous bandwidth, high resolution, and reconfigurable microwave photonic multi-beam forming for the microwave photonic phased array radar.

### CROSS-REFERENCE TO RELATED APPLICATIONS

The subject application is a continuation of PCT/CN2021/123519 filed on Oct. 13, 2021, which in turn claims priority on Chinese Patent Application No. CN202111122981.3 filed on Sep. 24, 2021 in China. The contents and subject matters of the PCT international stage application and Chinese priority application are incorporated herein by reference.

### TECHNICAL FIELD

The present invention relates to integrated microwave photonics, and in particular to a silicon-based reconfigurable microwave photonic multi-beam forming network chip.

### BACKGROUND ART

A common phased array radar, i.e., a phase control electronically scanned array radar, uses a large number of individually controlled small antenna elements arranged in the antenna array plane. Each antenna element is controlled by an independent phase shift unit. The interference pattern of the signal transmitted by each antenna element in a space can be changed by controlling the phase of the signal transmitted by each antenna element, thereby controlling the direction of beam transmission. The electromagnetic waves emitted by each antenna element of the phased array interfere to form a radar main lobe beam whose emission direction is close to straight, and the non-uniformity of each antenna element may form side lobes. The phased array radar fundamentally solves the inherent problems of the traditional mechanical scanning radar. At the same aperture and operating wavelength, the scanning speed, target update rate, multi-target tracking capability, resolution, versatility, electronic countermeasure capability, etc. of the phased array are far superior to those of the traditional radar.

In order to improve the anti-interference capability, the novel phased array radar must have a bandwidth as large as possible. In order to improve the radar resolution and recognition ability and solve the problem of multi-target imaging, the novel phased array radar must have a large instantaneous bandwidth and own multi-beam transmitting ability. In order to combat the threat of anti-radiation, spread spectrum signals with large instantaneous bandwidths are also required. Conventional coaxial cable delay lines, surface acoustic wave (SAW) delay lines, and charge-coupled devices (CCD) are not satisfactory. Magnetostatic wave device technology and superconducting delay line technology are far from practical use.

With the rapid development of optical fiber communication technology, various active and passive devices such as laser light sources, light detectors, light modulators, and light switches have been highly commercialized and marketed. Microwave photonic technology was born at the right moment. Compared with traditional electronic technology, it has the advantages of large instantaneous bandwidth, low loss, anti-electromagnetic interference and so on. Therefore, using optical true delay technology to develop the beam forming network of phased array radar becomes a research hotspot as a solution that may break through the electronic bottleneck.

Various optical beamformer schemes have been reported over the past decades. Among them, they are mostly based on optical phase shifters, switchable fiber delay matrices, liquid crystal polarization switching devices, wavelength tunable lasers, dispersive optical elements, etc. However, most of these are composed of discrete devices, which cause problems such as large system size and poor stability. Most of them are only single-beam forming networks. In order to reduce the system volume, mass and power consumption, and improve the stability and practicality, the integrated photonic technology is an inevitable choice to develop a high performance and high stability beamformer. Meanwhile, in order to improve the anti-interference capability and survivability of radar, make full use of the energy of the transmitting beam, and improve the flexibility of radar data rate and beamforming, it is necessary to establish a reconfigurable multi-beamforming network with an ultra-wideband.

At present, most of the research on microwave photonic multi-beamforming are on the level of discrete devices in academic world, and a few integration schemes still have obvious defects. On the discrete device side, Beatriz Ortega and Jose Mora et al. in Spain (IEEE Photon. J., 2016, 8(3) (2016)) disclose a beamforming network having two-dimensional array antennas with a wide range of angular deflection, which uses sub-array antenna division for the multi-beam function. A fixed multi-wavelength laser is used in the system, and a chirped fiber Bragg grating is used in conjunction with a fiber delay line to feed an array antenna. Depending on the specific application, the definition of the different subarrays allows up to four spatially multiplexed beams oriented in different directions to be present, limited by the characteristics of the discrete devices, with less precision and less stability. In terms of integration scheme, the research team at Zhejiang University (Opt. Commun., 2021, 489 (2021)) also adopts the method of sub-array division to expand the original 2D beamforming scheme into multi-beam independently controllable beamforming, which is relatively easy to implement. However, this scheme needs complex connections between multiple chips, has low integration degree, the maximum number of multi-beams formed and the number of array elements required for single-beam forming are fixed, and the back end also needs to be added with a microwave power distribution structure, which has poor flexibility and practicality.

### SUMMARY OF THE INVENTION

The present invention provides a network chip for a microwave photonic phased array radar that achieves large instantaneous bandwidth, high resolution, and reconfigurable microwave photonic multi-beam forming.

In order to achieve the above-mentioned object, the technical solution of the present invention is a silicon-based reconfigurable microwave photonic multi-beam forming network chip comprising an optical fiber coupler, an optical switch array, an optical divider, an ultra-wideband continuously adjustable optical true delay line array and a detector array; the optical fiber coupler is configured for inputting a single-sideband modulated optical signal of a microwave photonic phased array radar; the optical switch array and optical divider are configured for forming the reconstruction of the number of array elements used for a microwave photonic multi-beam and a microwave photonic single-beam; the ultra-wideband continuously adjustable optical true delay line array is configured for independently adjusting the delay on each microwave array element; and the detector array is configured for outputting a microwave signal.

Preferably, the above-mentioned silicon-based reconfigurable microwave photonic multi-beam forming network chip comprises N optical fiber couplers, an N× N optical switch array, N 1×M optical dividers, an N× M-path ultra-wideband continuously adjustable optical true delay line array and an N×M-path detector array; the input signals of the N optical fiber couplers are N-path single-sideband modulated optical signals with a carrier wavelength λ and a modulation signal being a microwave signal to be emitted; output ends of the N optical fiber couplers are respectively connected to N input ends of the N×N optical switch array; the N output ends of the N×N optical switch array are respectively connected to input ends of the N 1×M optical dividers; the output ends of the N 1×M optical dividers are respectively connected to input ends of the N×M-path ultra-wideband continuously adjustable optical true delay line array; the output ends of the N×M-path ultra-wideband continuously adjustable optical true delay line array are respectively connected to the input ends of the N×M-path detector array; and an output signal of the N×M-path detector array is a microwave signal with a maximum beam number being equal to N.

Preferably, the optical fiber coupler adopts a grating coupler structure or a mode spot converter structure for realizing optical coupling between an optical fiber and the chip.

Preferably, the N×N optical switch array comprises several 2×2 optical switch units and waveguide cross-junctions in a topology structure with Benes, Crossbar or a double-layer network structure; the 2×2 optical switch unit adopts a Mach-Zehnder interferometer structure, and the waveguide cross-junctions adopt a multi-mode interference structure; the 2×2 optical switch unit integrates a thermally tuned phase shifter or an electrically tuned phase shifter for realizing optical switch state switching; the states of the optical switches of the N×N optical switch array is adjusted to perform different routing paths so as to realize the function of a reconfigurable optical divider; and the splitting ratio of an input optical beam and an output optical beam of the N×N optical switch array is reconfigurable as 1:2, 1:4, . . . , or 1:N. Preferably, the 1×M optical divider evenly splits the input light into M-path output, and is constituted by a cascaded 1× 2 divider or a 1×M multi-mode interferometer structure; and the 1×2 divider adopts a multi-mode interferometer structure or a Y-type bifurcation structure.

Preferably, the N×M-path ultra-wideband continuously adjustable optical true delay array comprises N× M identical adjustable true delay lines in parallel.

Preferably, the adjustable true delay line comprises a first high-Q value up-downloading adjustable optical filter, a second high-Q value up-downloading adjustable optical filter and a cascaded microring delay line, and the first high-Q value up-downloading adjustable optical filter and the second high-Q value up-downloading adjustable optical filter have a same size; an input end of the adjustable delay line is connected to an input end of the first high-Q value up-downloading adjustable filter; a through end and a downloading end of the first high-Q value up-downloading adjustable filter are respectively connected to an input end of the cascaded microring delay line and a downloading end of the second high-Q value up-downloading filter; an output end of the cascaded microring delay line is connected to a through end of the second high-Q value up-downloading filter; and an output end of the second high-Q value up-downloading filter is connected to the output end of the cascaded microring delay line.

Preferably, the cascaded microring delay line comprises a cascade of a plurality of microrings, wherein free spectral ranges of first and second microrings are the same, both being FSR₁, and from a p^{th} microring (p>2), the free spectral range of the microring is 2^{p-2}×FSR₁; coupling regions of the plurality of microrings comprise a Mach-Zehnder interferometer structure on which a thermally or electrically tuned phase shifter for coupling coefficient adjustment is integrated; a thermally or electrically tuned phase shifter for tuning a microring resonance wavelength is integrated on the plurality of microrings, so that the carrier wavelength λ falls near the anti-resonance point wavelength of the first microring.

Preferably, the first high-Q value up-downloading adjustable optical filter and the second high-Q value up-downloading adjustable optical filter are composed of a microring up-downloading filter with a high-Q value; and a central wavelength filtered by the microring up-downloading filter is consistent with a carrier wavelength λ of an input signal, which is used for separating a carrier of the input signal from a modulation signal.

Preferably, in the microring up-downloading filter, the waveguide loss of the microring is reduced to increase the Q value by adopting a wide waveguide in the coupling region of the microring and an Euler bending waveguide structure in a bending part of the microring.

Preferably, the N×M-path detector array converts a delayed optical signal into a microwave signal, which is output by an antenna after being electrically amplified at a back end; and the detector comprises a vertical or horizontal PIN structure.

Preferably, the chip is prepared by the silicon-based integrated optoelectronic technology combined with germanium, silicon nitride and III-V material heterogeneous integration technology.

Compared with the current technology, the present invention has the following advantageous effects. Multi-beam emission is generated by adopting mature integrated photon technology and using the method of sub-array division. The reconstruction of the number of beamforming and the number of array elements used for a single beam are achieved by an optical switch array. A delay network is constituted by using an integrated adjustable optical true delay line to independently adjust the direction of each beam emission, achieving the large instantaneous bandwidth, high resolution, and reconfigurable multi-beam formation, greatly improving the flexibility and basic performance of microwave photonic radar beam formation.

With the N×N optical switch array used, and the topological structure thereof designed, the number of beams formed and the number of array elements required for the single beam can be reconstructed by adjusting the state of the optical switch. The input microwave optical signal can also be controlled to be output simultaneously on different sub-arrays or a plurality of sub-arrays.

The ultra-wideband continuously adjustable delay unit partially introduces the high-Q microring filter to separate the carrier wave and the modulated wave of the microwave optical signal, so as to improve the utilization rate of the flat delay bandwidth at the anti-resonance point of the cascaded microring optical delay line, and to greatly improve the working bandwidth of the system input microwave signal.

Each beam deflection angle formed is determined by the delay difference of adjacent adjustable delay lines in different ultra-wideband microwave photonic delay units. Therefore, the deflection angles of each beam may be independently controlled and do not interfere with each other.

The structure and control are simple. With the use of integrated photonic technology, it has the advantages of small size and low power consumption.

### BRIEF DESCRIPTION OF THE DRAWINGS

FIG. 1 shows the overall structure of the silicon-based reconfigurable microwave photonic multi-beam forming network chip according to the present invention.

FIG. 2 shows the structure of one embodiment of the silicon-based reconfigurable microwave photonic multi-beam forming network chip using a 4×4 optical switch array in the present invention.

FIG. 3 shows the structure of a 2×2 multi-mode interference structure optical switch unit in the silicon-based reconfigurable microwave photonic multi-beam forming network chip in the present invention.

FIG. 4 shows the structure of an optical switch unit with a 2×2 directional coupler structure in the silicon-based reconfigurable microwave photonic multi-beam forming network chip in the present invention.

FIG. 5 shows the structure of an optical beam splitter with a 1×2 multi-mode interference structure in the silicon-based reconfigurable microwave photonic multi-beam forming network chip of the present invention.

FIG. 6 shows the structure of a beam splitter with a 1×2Y-type beam splitter structure in the silicon-based reconfigurable microwave photonic multi-beam forming network chip of the present invention.

FIG. 7 shows the single-beam emission state formation for the silicon-based reconfigurable microwave photonic multi-beam forming network chip using a 4×4 optical switch array in the present invention.

FIG. 8 shows the dual-beam emission state formation for the silicon-based reconfigurable microwave photonic multi-beam forming network chip using a 4×4 optical switch array in the present invention.

FIG. 9 shows the four-beam emission state formation for the silicon-based reconfigurable microwave photonic multi-beam forming network chip using a 4×4 optical switch array in the present invention.

FIG. 10 shows the structure and operation principle of an ultra-wideband continuously adjustable delay unit in the silicon-based reconfigurable microwave photonic multi-beam forming network chip of the present invention.

FIG. 11 shows detailed structure of a high-Q microring filter used in an ultra-wideband continuously adjustable delay unit in the silicon-based reconfigurable microwave photonic multi-beam forming network chip of the present invention.

FIG. 12 shows details of a microring-assisted Mach-Zehnder interference structure for a cascaded microring delay line of an ultra-wideband continuously adjustable delay unit in the silicon-based reconfigurable microwave photonic multi-beam forming network chip of the present invention.

### DETAILED DESCRIPTION OF THE INVENTION

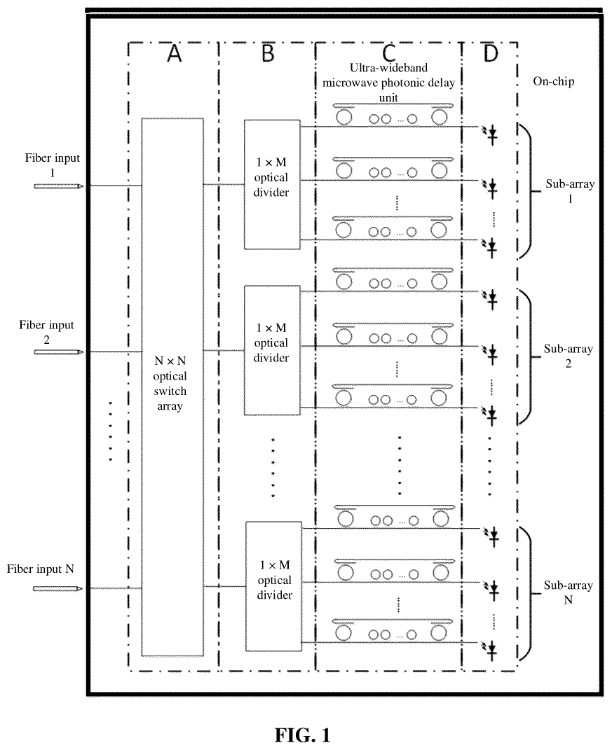

The present invention implements a silicon-based reconfigurable microwave photonic multi-beam forming network chip, the overall structure of which is shown in FIG. 1. The embodiment shown in FIG. 2 is a specific embodiment of the present invention in the case of a 4×4 optical switch array. The structure specifically includes one 4×4 optical switch array, four 1×4 optical dividers, a 16-path ultra-wideband continuously adjustable optical true delay line array and a 16-path detector array. Input signals of four optical fiber couplers are four-path single-sideband modulated optical signals with a carrier wavelength λ and a modulation signal being a microwave signal to be emitted. Output ends of the four optical fiber couplers are respectively connected to four input ends of the 4×4 optical switch array. F our output ends of the 4×4 optical switch array are respectively connected to the input ends of the four 1×4 optical dividers. The output ends of the four 1×4 optical dividers are respectively connected to input ends of the 16-path ultra-wideband continuously adjustable optical true delay line array. The output ends of the 16-path ultra-wideband continuously adjustable optical true delay line array are respectively connected to the input ends of the 16-path detector array. An output signal of the 16-path detector array is a microwave signal with a maximum beam number being equal to four.

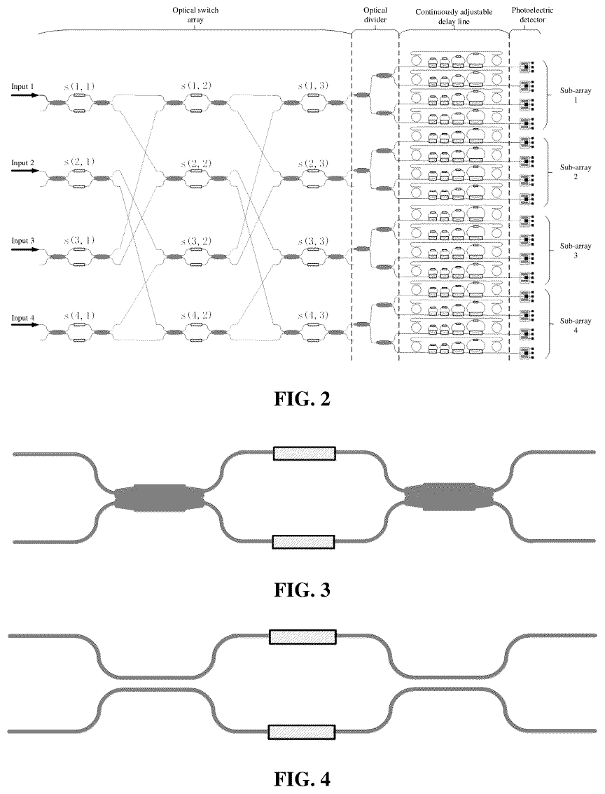

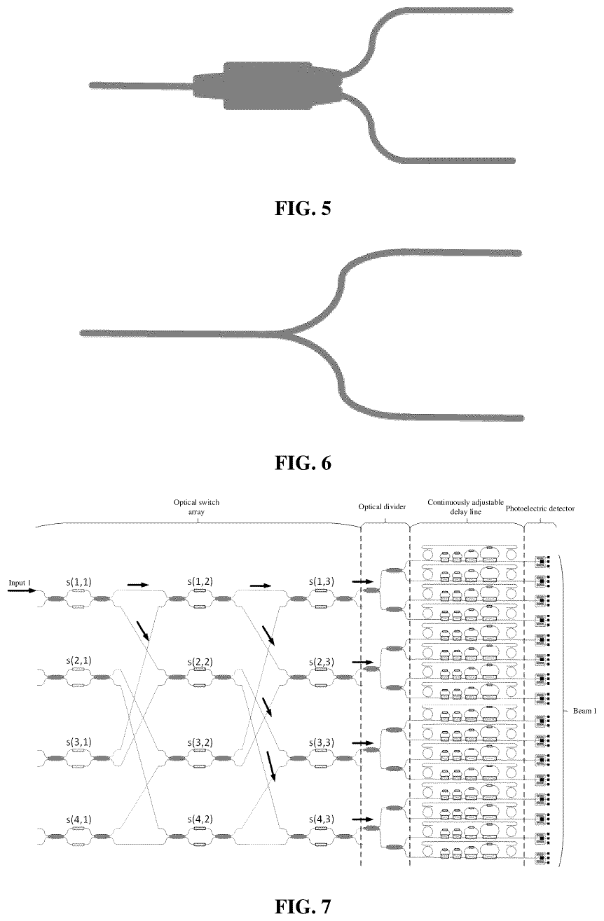

As shown in FIGS. 3 and 4, the optical switching unit in the embodiment may employ an optical switching unit based on a 2×2 directional coupler structure or a 2× 2 multi-mode interference structure. As shown in FIGS. 5 and 6, the 1×4 optical divider in the embodiment may be cascaded by a 1×2 multi-mode interference structure or a 1×2Y-type beam splitter.

### 1. Multi-Beam Reconstruction Process

A single optical switch in a 4×4 optical switch array has three states of crossed, through and 3-dB optical splitting. The operating state of each optical switch is changed by adjusting the voltages applied by phase shifters on two arms. Here, s (i, j) (i=1, 2, 3, 4, j=1, 2, 3) represents an optical switch of an i^{th} row and a j^{th} column. The implementation process of three different multi-beam emission states of a single-beam (the single beam is emitted by sixteen array elements), a double-beam (the single beam is emitted by eight array elements), and a four-beam (the single beam is emitted by four array elements) is respectively described below.

FIG. 7 is a schematic diagram of single-beam emission state formation for a silicon-based reconfigurable microwave photonic multi-beam forming network chip based on a 4×4 optical switch array. In a silicon-based reconfigurable microwave photonic multi-beam forming network chip using a 4×4 optical switch array in the present embodiment, when the control optical switches s (1, 1), s (1, 2) and s (2, 2) are in a 3-dB splitting state, and the optical switches s (1, 3), s (2, 3), s (3, 3) and s (4, 3) are all in a through state, the transmission path of the single sideband microwave optical signal in the beam forming network chip is as shown in FIG. 7. At this time, all 16 microwave transmitting array elements are used to realize the emission of one beam.

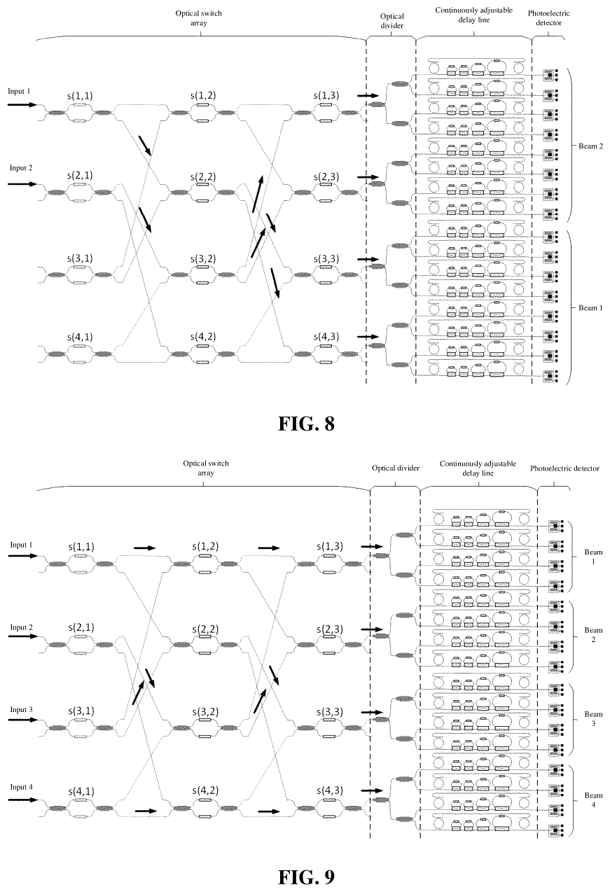

FIG. 8 is a schematic diagram of dual-beam emission state formation for a silicon-based reconfigurable microwave photonic multi-beam forming network chip using a 4×4 optical switch array. In a silicon-based reconfigurable microwave photonic multi-beam forming network chip using a 4×4 optical switch array in the present embodiment, when the optical switches s (2, 2) and s (3, 2) are controlled to be in a 3-dB splitting state, the optical switches s (1, 1), s (2, 1), s (3, 3) and s (4, 3) are controlled to be in a through state, and the optical switches s (1, 3) and s (2, 3) are all controlled to be in a crossed state, the transmission path of the single sideband microwave optical signal in the beam forming network chip is as shown in FIG. 8. Double beam forming can be realized at this time. Every 8 microwave emission array elements participate in the emission of one beam.

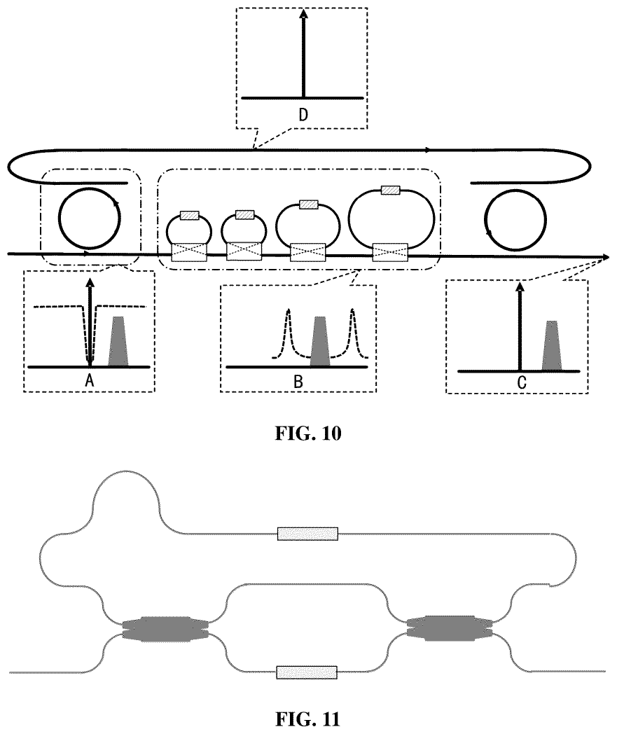

FIG. 9 is a schematic diagram of four-beam emission state formation for a silicon-based reconfigurable microwave photonic multi-beam forming network chip using a 4×4 optical switch array. In a silicon-based reconfigurable microwave photonic multi-beam forming network chip using a 4×4 optical switch array in the present embodiment, when the control optical switches s (1, 1), s (2, 1), s (1, 2), s (4, 2), s (1, 3) and s (3, 3) are all in a through state, and the optical switches s (3, 1), s (4, 1), s (2, 2), s (3, 2), s (2, 3) and s (4, 3) are all in a crossed state, the transmission path of the single sideband microwave optical signal in the beam forming network chip is as shown in FIG. 9. At this time, four sub-arrays emit different input beams. Every four microwave emission array elements participate in the formation of one beam.

### 2. Structure and Working Principle of Ultra-Wideband Adjustable Delay Unit

FIG. 10 is a schematic diagram showing the structure and operation principle of an ultra-wideband continuously adjustable delay unit in a silicon-based reconfigurable microwave photonic multi-beam forming network chip. As shown in FIG. 10, it comprises a first high-Q value up-downloading adjustable optical filter, a second high-Q value up-downloading adjustable optical filter and a cascaded microring delay line, and the first high-Q value up-downloading adjustable optical filter and the second high-Q value up-downloading adjustable optical filter have a same size. An input end of the adjustable delay line is connected to an input end of the first high-Q value up-downloading adjustable filter. A through end and a downloading end of the first high-Q value up-downloading adjustable filter are respectively connected to an input end of the cascaded microring delay line and a downloading end of the second high-Q value up-downloading filter. An output end of the cascaded microring delay line is connected to a through end of the second high-Q value up-downloading filter. An output end of the second high-Q value up-downloading filter is connected to the output end of the cascaded microring delay line. A central wavelength filtered by the microring up-downloading filter is consistent with a carrier wavelength λ of an input signal, which is used for separating a carrier of the input signal from a modulation signal. In this embodiment, the operation process of a single delay unit is as follows. After a single-sideband modulated optical signal (including a carrier and a sideband signal on one side) passes through a high-Q value microring filter, the carrier therein is filtered out (as shown in A of FIG. 10). The sideband signal therein is individually subjected to delay adjustment by a continuously adjustable delay line of a cascade microring type (as shown in B of FIG. 10). The carrier passes through a section of waveguide and then passes through the same high-Q value microring filter to re-combine the carrier with the sideband signal passing through the continuously adjustable delay line (as shown in C of FIG. 10), so as to achieve the whole process of carrier separation and re-combination.

The cascaded microring delay line consists of four microrings (MRR), denoted R1, R2, R3 and R4, respectively. The round trip times ti (i=1, 2, 3, 4) for the four MRR are designed to be 30 ps, 30 ps, 60 ps, and 120 ps. A 2× 2 symmetric MZI adjustable coupler is used on a bus waveguide and a microring coupling region to adjust an equivalent coupling coefficient. A thermo-optic (TO) phase shifter is placed in a lower arm of the MZI coupler. By adjusting the voltage applied to an upper arm to control the phase difference between the two arms so as to adjust the coupling coefficient, the equivalent coupling coefficient of MRR may be theoretically adjusted from 0 to 1. The waveguide on the MRR is integrated with another thermally tuned phase shifter to tune the resonant wavelength. There are etched air trenches beside each thermally tuned phase shifter to prevent thermal crosstalk.

FIG. 11 is a detailed diagram of a microring-assisted Mach-Zehnder interference structure for a cascaded microring delay line of an ultra-wideband continuously adjustable delay unit in the embodiment. As shown in FIG. 11, in the present embodiment, the cascaded microring delay line of the ultra-wideband continuously adjustable delay unit adopts a single MRR, which is formed by connecting one input port to an output port of an equal-arm MZI. The transmission matrix method is used to describe the transmission characteristic and the delay characteristic of the structure.

For an equal arm MZI, and MMI is a 3 dB coupler, there is

$$[ \begin{matrix}{E}_{t 1} \\ {E}_{t 2}\end{matrix} ] = - j {e}^{- j {ϕ}_{c}} [ \begin{matrix}sin {Δϕ}_{d} & cos {Δϕ}_{d} \\ cos {Δϕ}_{d} & - sin {Δϕ}_{d}\end{matrix} ] [ \begin{matrix}{E}_{i 1} \\ {E}_{i 2}\end{matrix} ] \qquad ( 1 )$$

The transmission function obtained after one week of propagation of the microring is

$${T}_{r} = j {e}^{- j ( 2 {ϕ}_{c} + {θ}_{r} )} \frac{{ρ}_{r}^{*} - {z}^{- 1}}{1 - {ρ}_{r} {z}^{- 1}} \qquad ( 2 )$$

$${θ}_{r} = ω τ + θ = \frac{2 π {n}_{e f f} {L}_{r}}{λ} + θ \qquad ( 3 )$$

where Or is the phase change on the microring, with one part introduced by the optical path of the light after passing through one cycle of the ring (ωt), and the other part introduced by the thermally tuned phase shifter on the microring (θ); ω and r respectively represent the frequency of the input light and the time required for the light to travel one cycle on the microring; ρᵣ=e^{-j(ϕ}^{_{c}}^{+θ}^{ᵣ}⁾sin Δϕ_{d} is the pole of the transfer function of the microring resonator; ρᵣ and ρᵣ*are conjugate complex pairs; z⁻¹=αe^{-jωτ} is the tranmission function of the light in the microring; and thus the obtained equivalent coupling coefficient of the microring is k=1−|ρᵣ|²=cos²Δϕ_{d}.

The adjustment of MRR is achieved by controlling two phase shifters. The phase difference Add on MZI affects the coupling coefficient of the microring. The coupling coefficient of the microring may be changed from 0 to 1 theoretically by adjusting Δϕ_{d}. The common phase ϕ_{c} of the MZI and the phase θ on the microring affect the resonance position of the microring. When the MZI is in the through state (κ=0), the optical signal does not pass through the microring and the entire structure becomes a single waveguide with zero delay. When the MZI is in the crossed state (κ=1), the light passes through the microring only once. In this case it is equivalent to a delay line with a delay time T.

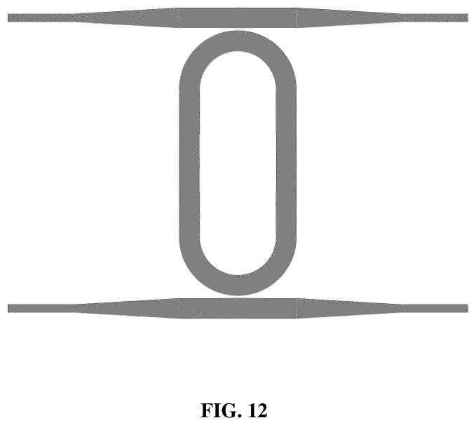

FIG. 12 is a detailed view of a structure of a high-Q microring filter used in an ultra-wideband continuously adjustable delay unit in the embodiment. As shown in FIG. 12, the coupling region of the high-Q microring filter adopts a wide waveguide, and the bending part of the microring adopts an Euler bending structure to improve the Q value. Specifically, this embodiment adopts two microring up-downloading filter structures to achieve carrier and signal sideband separation and synthesis. The carrier is output from a download end (Drop). The signal sideband is directly output from a through end (Through). The spectrum changes of the microwave optical signal before and after passing through the microring filter are shown as A, B, C and D in FIG. 10 of the drawings.

The above mentioned are embodiments of the present invention. It is understood by those skilled in the art that on the premise of not deviating from the principle of the present invention, several improvements and supplements may be made, and these improvements and supplements shall also fall in the scope of protection of the present invention.

We claim:

1. A silicon-based reconfigurable microwave photonic multi-beam forming network chip, comprising an optical fiber coupler,
an optical switch array,
an optical divider,
an ultra-wideband continuously adjustable optical true delay line array, and
a detector array,
wherein the optical fiber coupler is configured for inputting a single-sideband modulated optical signal of a microwave photonic phased array radar;
the optical switch array and optical divider are configured for forming the reconstruction of the number of array elements used for a microwave photonic multi-beam and a microwave photonic single-beam;
the ultra-wideband continuously adjustable optical true delay line array is configured for independently adjusting the delay on each microwave array element; and
the detector array is configured for outputting a microwave signal.

2. The silicon-based reconfigurable microwave photonic multi-beam forming network chip according to claim 1, wherein the chip comprises N optical fiber couplers, an N×N optical switch array, N 1×M optical dividers, an N×M-path ultra-wideband continuously adjustable optical true delay line array and an N×M-path detector array;
the input signals of the N optical fiber couplers are N-path single-sideband modulated optical signals with a carrier wavelength λ and a modulation signal being a microwave signal to be emitted;
output ends of the N optical fiber couplers are respectively connected to N input ends of the N×N optical switch array;
the N output ends of the N×N optical switch array are respectively connected to input ends of the N 1×M optical dividers;
the output ends of the N 1×M optical dividers are respectively connected to input ends of the N×M-path ultra-wideband continuously adjustable optical true delay line array;
the output ends of the N×M-path ultra-wideband continuously adjustable optical true delay line array are respectively connected to the input ends of the N×M-path detector array; and
an output signal of the N×M-path detector array is a microwave signal with a maximum beam number being equal to N.

3. The silicon-based reconfigurable microwave photonic multi-beam forming network chip according to claim 2, wherein the optical fiber coupler comprises a grating coupler structure or a mode spot converter structure for realizing optical coupling between an optical fiber and the chip.

4. The silicon-based reconfigurable microwave photonic multi-beam forming network chip according to claim 2, wherein the N×N optical switch array comprises several 2×2 optical switch units and waveguide cross-junctions in a topology structure with Benes, Crossbar or a double-layer network structure;
the 2×2 optical switch unit adopts a Mach-Zehnder interferometer structure, and the waveguide cross-junctions adopt a multi-mode interference structure;
the 2×2 optical switch unit integrates a thermally tuned phase shifter or an electrically tuned phase shifter for realizing optical switch state switching;
the states of the optical switches of the N×N optical switch array is adjusted to perform different routing paths so as to realize the function of a reconfigurable optical divider; and
the splitting ratio of an input optical beam and an output optical beam of the N×N optical switch array is reconfigurable as 1:2, 1:4, . . . , or 1:N.

5. The silicon-based reconfigurable microwave photonic multi-beam forming network chip according to claim 2, wherein the 1×M optical divider evenly splits the input light into M-path output, and is constituted by a cascaded 1×2 divider or a 1×M multi-mode interferometer structure; and
the 1×2 divider adopts a multi-mode interferometer structure or a Y-type bifurcation structure.

6. The silicon-based reconfigurable microwave photonic multi-beam forming network chip according to claim 2, wherein the N×M-path ultra-wideband continuously adjustable optical true delay array comprises N×M identical adjustable true delay lines in parallel.

7. The silicon-based reconfigurable microwave photonic multi-beam forming network chip according to claim 6, wherein the adjustable true delay line comprises a first high-Q value up-downloading adjustable optical filter, a second high-Q value up-downloading adjustable optical filter and a cascaded microring delay line, and the first high-Q value up-downloading adjustable optical filter and the second high-Q value up-downloading adjustable optical filter have a same size;
an input end of the adjustable delay line is connected to an input end of the first high-Q value up-downloading adjustable filter;
a through end and a downloading end of the first high-Q value up-downloading adjustable filter are respectively connected to an input end of the cascaded microring delay line and a downloading end of the second high-Q value up-downloading filter;
an output end of the cascaded microring delay line is connected to a through end of the second high-Q value up-downloading filter; and
an output end of the second high-Q value up-downloading filter is connected to the output end of the cascaded microring delay line.

8. The silicon-based reconfigurable microwave photonic multi-beam forming network chip according to claim 7, wherein the cascaded microring delay line comprises a cascade of a plurality of microrings, wherein free spectral ranges of first and second microrings are the same, both being FSR₁, and from a p^{th} microring (p>2), the free spectral range of the microring is 2^{p-2}×FSR₁;
coupling regions of the plurality of microrings comprise a Mach-Zehnder interferometer structure, and a thermally or electrically tuned phase shifter for coupling coefficient adjustment is integrated on the Mach-Zehnder interferometer structure; and
a thermally or electrically tuned phase shifter for tuning a microring resonance wavelength is integrated on the plurality of microrings, so that the carrier wavelength λ falls near the anti-resonance point wavelength of the first microring.

9. The silicon-based reconfigurable microwave photonic multi-beam forming network chip according to claim 7, wherein the first high-Q value up-downloading adjustable optical filter and the second high-Q value up-downloading adjustable optical filter comprise a microring up-downloading filter with a high-Q value; and
a central wavelength filtered by the microring up-downloading filter is consistent with a carrier wavelength λ of an input signal, and the microring up-downloading filter with a high-Q value is used for separating a carrier of the input signal from a modulation signal.

10. The silicon-based reconfigurable microwave photonic multi-beam forming network chip according to claim 9, wherein in the microring up-downloading filter, the waveguide loss of the microring is reduced to increase the Q value by adopting a wide waveguide in the coupling region of the microring and an Euler bending waveguide structure in a bending part of the microring.

11. The silicon-based reconfigurable microwave photonic multi-beam forming network chip according to claim 2, wherein the N×M-path detector array converts a delayed optical signal into a microwave signal, and the converted microwave signal is output by an antenna after being electrically amplified at a back end; and
the detector comprises a vertical or horizontal PIN structure.

12. The silicon-based reconfigurable microwave photonic multi-beam forming network chip according to claim 2, wherein the chip is prepared by the silicon-based integrated optoelectronic technology combined with germanium, silicon nitride and III-V material heterogeneous integration technology.
